(19) United States
(12) Patent Application Publication
(10) Pub. No.: US 2005/0010957 A1
(43) Pub. Date: Jan. 13, 2005

(54) Method and a system for communicating bandwidth information of a digital broadcast network

(76) Inventors: Dominique Muller, Helsinki (FI); Tuomo Saarikivi, Helsinki (FI)

Correspondence Address: MORGAN & FINNEGAN, L.L.P., 3 WORLD FINANCIAL CENTER, NEW YORK, NY, 10281-2101, US

(21) Appl. No.: 10/496,422

(22) PCT Filed: Nov. 18, 2002
(86) PCT No.: PCT/FI02/00913

(30) Foreign Application Priority Data
Nov. 20, 2001 (FI) 20012255

(51) Int. Cl. H04N 7/173; H04N 7/20; H04N 7/16

(52) U.S. Cl. 725/95; 725/62; 725/63

(57) ABSTRACT

In an embodiment of the invention the Network Operator (NO) manages the available bandwidth of the digital broadcast network in time-dependent manner. The NO announces the available bandwidth to the datacast operator (DCO) via an interface for a certain period of time. The interface is a data connection intermediator between the NO and the DCO. A network of computing systems couples the NO with the DCO. Advantageously, the network of computing systems comprises Internet. The DCO, which makes use of the NO's bandwidth for distributing electronic media to end-users, reserves some bandwidth for a certain period of time in accordance with the need, which the DCO obtains from a Content Provider (CP). The content is broadcast to the end-user in accordance with a schedule which is based on the bandwidth availability. Thus, the content is multicast via the digital broadcast network which is maintained by the network operator (NO).

### TECHNICAL FIELD OF THE INVENTION

This invention relates to systems and methods for distributing data over a wireless link.

### BACKGROUND OF THE INVENTION

Broadcast has an almost century long tradition in radio. Even with TV, the history goes back to 1930's. Broadcasting has been successful throughout the world in bringing both entertainment and information to mass audiences.

The latest step in broadcasting is the digitalisation of both radio and TV. Digital radio has not gained much acceptance on the market. However, many hope that digital TV will bring new benefits and services to the consumer and, as a result, generate new revenue streams for the broadcasting industry. The basic concept of the TV service itself has, however, not changed much. Rather, the TV lives on as before even if it has become digital.

In later half of 1990's we saw the boom of the Internet. A whole set new of services and content became available to the consumers during a short, revolutionary and hype intense period. That period introduced e-commerce, Internet Service Providers (ISPs), Portals, eyeballs game, dotcom companies and even the new economy. The developments in both access technologies (e.g. ADSL) and coding technologies (e.g. MPEG-2 streaming) has made it possible to bring rich media content like video content to homes via the Internet. Despite of these technology and market breakthroughs media houses have been reluctant to distribute their content via the Internet due to its “free-of-charge” nature and the direct threat of piracy. Internet has also not been able to challenge the role of traditional media as the primary advertisement platform despite is great popularity.

Another development marking major shifts in the 1990's has been the rapid growth of mobile telecommunications globally. Through out the world voice telephony has moved from fixed wireline to mobile wireless. Consumers have an urge for new, mobile non-voice services that operators hope to fulfil with latest developments of technology like GPRS and 3rd Generation UMTS. In Japan DoCoMo by orchestrating the iMode business system and technology platform managed to boost the market with new services, new benefits to both consumers and content providers, and, consequently, with new revenue streams.

A digital broadcasting can distribute data information today. Despite the high transmission ability of the broadcast, the broadcast resources are limited. Therefore, there is a need to control the broadcast transmission resources for services that are delivered to a broadcast network from various sources.

### SUMMARY OF THE INVENTION

Now a method and a system has been invented where bandwidth information of a digital broadcast network is communicated between a datacast operator and a network operator.

In accordance with a first aspect of the invention there is provided a method for communicating bandwidth information of a digital broadcast network between a datacast operator, which datacast operator arranges data content to a network operator, and the network operator operating the digital broadcast network, the method comprising:
announcing available bandwidth of at least one channel of the digital broadcast network to the datacast operator for a period of time by the network operator of the digital broadcast network, and
reserving at least part of said announced bandwidth of the digital broadcast network for said period of time by the datacast operator.

In an embodiment of the invention the Network Operator (NO) manages the available bandwidth of the digital broadcast network in time-dependent manner.

The NO announces the available bandwidth to the datacast operator (DCO) via an interface for a certain period of time. The interface is a data connection intermediator between the NO and the DCO. A network of computing systems couples the NO with the DCO. Advantageously, the network of computing systems comprises Internet. The DCO, which makes use of the NO's bandwidth for distributing electronic media to end-users, reserves some bandwidth for a certain period of time in accordance with the need, which the DCO obtains from a Content Provider (CP). The content is broadcast to the end-user in accordance with a schedule which is based on the bandwidth availability. Thus, the content is multicast via the digital broadcast network which is maintained by the network operator (NO).

In accordance with a second aspect of the invention there is provided a method for communicating bandwidth information of a digital broadcast network between a datacast operator, which datacast operator arranges data content to a network operator, and the network operator operating the digital broadcast network, the method comprising:
at least one available bandwidth announcement is sent from the network operator to the datacast operator in order to announce available bandwidth of at least one channel of the digital broadcast network for a transmission via the digital broadcast network for the datacast operator.

In accordance with a third aspect of the invention there is provided a method for communicating bandwidth information of a digital broadcast network between a datacast operator, which datacast operator arranges data content to a network operator, and the network operator operating the digital broadcast network, the method comprising:
at least one bandwidth reservation request is sent from the datacast operator to the network operator in order to reserve bandwidth of at least one channel of the digital broadcast network for a transmission via the digital broadcast network for the datacast operator.

In some embodiments of the invention the datacast operator (DCO) can reserve the bandwidth. The bandwidth may not be confirmed by the network operator (NO) but the bandwidth can be used for the transmission. However, the transmission may not be guaranteed now.

In accordance with a fourth aspect of the invention there is provided a system for communicating bandwidth information of a digital broadcast network between a datacast operator, which datacast operator arranges data content to a network operator, and the network operator operating the digital broadcast network, the system comprising:
a first computing system of the network operator for announcing available bandwidth of at least one channel of the digital broadcast network to the datacast operator, wherein the first computing system is coupled with the network of computing systems and with the digital broadcast network,
a second computing system of the datacast operator for reserving bandwidth of at least one channel of the digital broadcast network from the network operator, wherein the second computing system is coupled with a network of computing systems and with the digital broadcast network, and
the digital broadcast network is for multicasting data content wirelessly to at least one end-user.

In some embodiments of the invention end-user(s) has a wireless terminal for receiving content via the digital broadcast network and for interaction via at least the network of computing system. Preferably, the digital broadcast network comprises terrestrial digital video broadcasting network (DVB-T) and the network of computing systems comprises Internet in the system. Moreover, the first computing system comprises a datacast service system operated by the dacast operator. An interface between the datacast operator and the network operator for intermediating bandwidth information in time-dependent manner is maintained.

In accordance with a fifth aspect of the invention there is provided an interface for communicating bandwidth information of at least one channel of a digital broadcast network between a datacast operator, which datacast operator arranges data content to a network operator, and the network operator operating the digital broadcast network, wherein the interface is set up at a computing system of the network operator and at a computing system of the datacast operator, the interface being adapted to transfer:
a bandwidth announcement to the datacast operator, the bandwidth announcement which the network operator makes available to the datacast operator for datacasting for a period of time, and
a bandwidth reservation request to the network operator, the bandwidth reservation request which the datacast operator needs for datacasting for a period of time.

Preferably, the interface comprises a web site, which is maintained commonly by the datacast operator and the network operator, providing a connection between the operators via Internet.

In accordance with the sixth aspect of the invention there is provided a computer program product comprising programs of instructions executable by a computer for communicating bandwidth information of at least one channel of a digital broadcast network between a datacast operator, which datacast operator arranges data content to a network operator, and the network operator operating the digital broadcast network, the computer program product comprising:
computer program code for causing the computer to announce available bandwidth of at least one channel of the digital broadcast network to a datacast operator for a period of time by the network operator of the digital broadcast network,
computer program code for causing the computer to reserve the bandwidth of the digital broadcast network for a period of time by the datacast operator,
wherein the bandwidth is specified in a time-dependent manner.

### BRIEF DESCRIPTION OF THE DRAWINGS

The invention will now be described, by way of example only, with reference to the accompanying drawings, in which:

FIG. 1 shows an overview of the Internet Protocol datacast (IPDC) service system architecture in accordance with an embodiment of the invention,

FIG. 2 shows a bandwidth scheduling in accordance with a further embodiment of the invention,

FIG. 3 shows an overview of the system and the procedure where the principles of the invention are applied,

FIG. 4 shows an example of a system where a web-site intermediates bandwidth information between a datacast operator and a network operator,

FIG. 5 shows an embodiment of a system architecture of the IPDC service system.

### DETAILED DESCRIPTION OF THE VARIOUS EMBODIMENTS

Terrestrial Digital Video Broadcasting (DVB-T) offers high bandwidth transmission channels, wherein delivery is typically multicast, and is, because of its broad bandwidth at low costs, the preferred distribution network not only for video, but also for electronic content in general. Planning is necessary to make optimum use of the available bandwidth. The planning of the bandwidth use is an important generic concept, which is also applicable on other multicast-enabled network implementations that might be used alternatively, such as multicast via Internet.

A Content Provider (CP) uses a datacast infrastructure, which comprises a datacast service system and a distribution network, to deliver services to end-users (EU). The datacast infrastructure provides ability to multicast IP based data.

A datacast operator (DCO) runs the datacast service system and can provide file downloading, streaming, and messaging. The DCO operates as a broker between the CP and a Network Operator (NO). The DCO is a customer of the Network Operator (NO). A system of the NO is used for transmitting the services to the EU via multicast. Preferably, the system of the NO is at least partly a digital broadcast network comprising a wireless link to the EU.

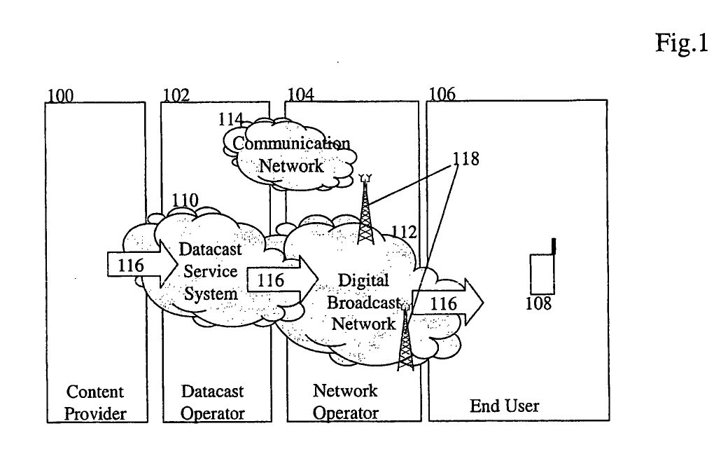

FIG. 1 has been described in the foregoing. In the following, corresponding reference signs have been applied to corresponding parts. A datacast operator (DCO) 102 is responsible for staging content (116) from various content providers (CP) 100, scheduling the content (116) according to the available bandwidth, and distributing it to end-users (EU) 108 using, for example multicast, via a digital broadcast network (112) which is maintained by a network operator (NO) 104. This functionality is supported, and as far as possible automated, by a datacast service system (DCSS) 110, which is run by the DCO (102). The DCSS (110) can transfer IP based packet data. The DCSS (110) can be a Local Area Network (LAN). The digital broadcast network (112) comprises an ability to distribute broadcast transmissions wirelessly. In addition the digital broadcast network (112) can distribute IP based data information. The digital broadcast network (112) is preferably Digital Video Broadcasting (DVB) network. Advantageously, the digital broadcast network is terrestrial digital video broadcasting (DVB-T) network.

In some embodiments of the invention, before wireless transmission, the data, which is received within or from the DSSS (110) is processed in the DBN (112). As is well known in the art, IP encapsulators (not shown) perform a multi-protocol encapsulation and places the IP data into Moving Picture Experts Group-Transport Stream (MPEG-TS) based data containers. According to embodiments, the operation of a Multi-Protocol Encapsulation (MPE) module may involve placing the received data into UDP (User Datagram Protocol) packets, which are encapsulated within IP packets, which are in turn encapsulated into DVB packets. Details of this MPE (Multi-Protocol Encapsulation) technique may be found, for example, in standard document EN 301 192, incorporated herein as a reference. At the application layer, usable protocols include UHTTP (unidirectional HTTP), RTSP (Real-Time Streaming Protocol), RTP (Real-time Transport Protocol), SAD/SDP (Service Announcement Protocol/Service description Protocol) and FTP.

In certain further embodiments, IP encapsulation may make use of IPSEC (Internet Protocol Security) to ensure that content (116) will only be usable by receivers with the appropriate credentials. During the encapsulation process, a unique identifier may be added to at least one of the headers. For example, when UHTTP is used, the unique identifier may be encoded in the UHTTP header under the UUID field. Therefore in certain embodiments, to cater for the delivery of data to a particular terminal or group of terminals, the containers may also hold address information which can be identified and read by a conditional access component in the wireless terminal 108 to determine whether the data is intended for that terminal. Alternatively, to cater for the delivery of data to a plurality of terminals multicast can be applied, and advantageously single sender can reach multiple receivers. A Virtual Private Network (VPN) can also be formed in the system of the DBN (112), and the wireless terminal (108) in such a way that only certain wireless terminal(s) (108) can receive certain wirelessly broadcast data. A certain bandwidth of the DBN (112) broadcasting is allocated to a point-to-point or point-to-multipoint communication from the DBN (112) to the wireless terminal (108). The DBN (112) may also have various transmission channels for other streams running. The wireless terminal 108 performs a multi-protocol decapsulation to form the IP data packets.

The DVB packets so produced are transmitted over the DVB wireless link as is known in the art. The wireless terminal (108) receives digitally broadcast data. The wireless terminal (108) can show the user service guide, and the user can consume the provided service using the wireless terminal (108). When a transmission rate is specified by the caster, that rate Is adhered to.

Still referring to FIG. 1, via a network of computing systems (114), the DCSS (110) can exchange information with the system of the NO (104) that maintains and operates the digital broadcast network (112). The preferred implementation of the network of computing systems (114) is the Internet, but alternatively a leased line, dial-up network, or other network providing packet based data connection can be used.

The end-user's (108) terminal is preferably the wireless terminal (108). Alternatively, a fixed digital broadcast receiver, which is coupled with a computer via Universal Serial Bus (USB), can be applied.

In the example of FIG. 1, the DBN 112 comprises transmission stations (118) sometimes also referred to as cells of the DBN 112. Each station/cell can have independent transmission forming at least one independent channel per cell. The available bandwidth of the DBN (112) is mainly formed by the available bandwidth for the channel.

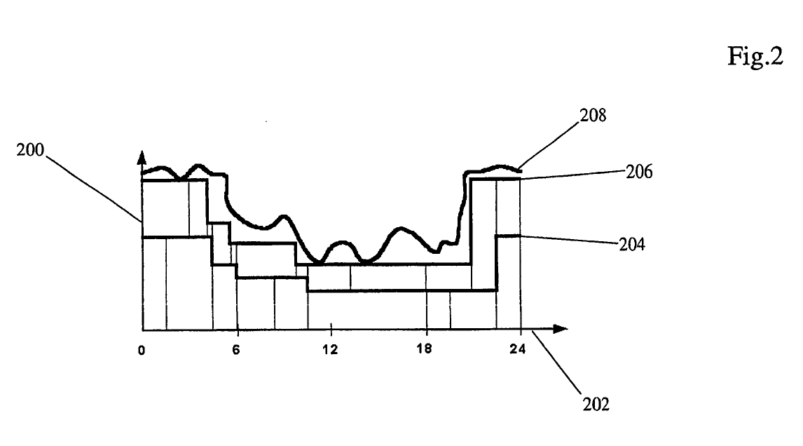

FIG. 2 has also been described in the foregoing. FIG. 2 illustrates three classes of bandwidth in accordance with an embodiment of the invention. The three classes of the bandwidth, of which two can be announced, are guaranteed bandwidth, forecast bandwidth and opportunistic bandwidth. The y-axis (200) represents channel bandwidth and x-axis (202) represents time in hours. The bandwidth availability is maintained for each channel in the digital broadcast network (112) separately. The bandwidth is announced by specifying a set of time frames (called “slots”, rectangles in the FIG. 2 inside which neither the bit rate nor its cost varies. The bandwidth, which is announced by specifying the set of time frames, can be either guaranteed bandwidth or forecast bandwidth. Guaranteed bandwidth (204) is announced exclusively to the DCO (102). The guaranteed bandwidth (204) can, for certain, be used for datacasting (unless a technical failure prevents this).

Forecast bandwidth (206) can be announced by the NO (104) to the DCO (102), for example to multiple operators (TV or datacast).

Opportunistic bandwidth (208) can be used by a selected operator only (from several operators competing for the NO's bandwidth). This is bandwidth that hasn't been reserved by any operator. The opportunistic bandwidth (208) can also be bandwidth which is not used despite having been reserved. The opportunistic bandwidth (208) will never be announced, however, an estimate based on experience with similar day types might be given. But the bandwidth is available and can be used for transmissions that are not time-dependent.

From the announced bandwidth (204, 206), the DCO (102) can construct a datacast schedule that defines when and at what bit rate what content (116) is distributed via the digital broadcast network (112). For the scheduling of content distribution, the DCO (102) can use the guaranteed (204) and—at its own risk—also the forecast bandwidth (206). The bandwidth is maintained, announced and reserved in time-dependent manner.

As the delivery date approaches, the DCO (102) will usually know more and more about the need for bandwidth on a given date on a given channel. The DCO can then make reservations inside the guaranteed bandwidth (204) and/or requests for more guaranteed bandwidth inside the forecast bandwidth (206).

Some further embodiments of the invention uses an interaction channel which provides the end-user (108) with means for interaction with the broadcasting service that he is receiving. Details of this interaction channel may be found, for example, in standards document EN 301 195, incorporated herein as a reference. The interaction channel provides the end-user (108) with means for registering to the DCO (102). The user can also browse a service guide via the interaction channel. The user can also subscribe a service, possibly various services, via the interaction channel or purchase the service item.

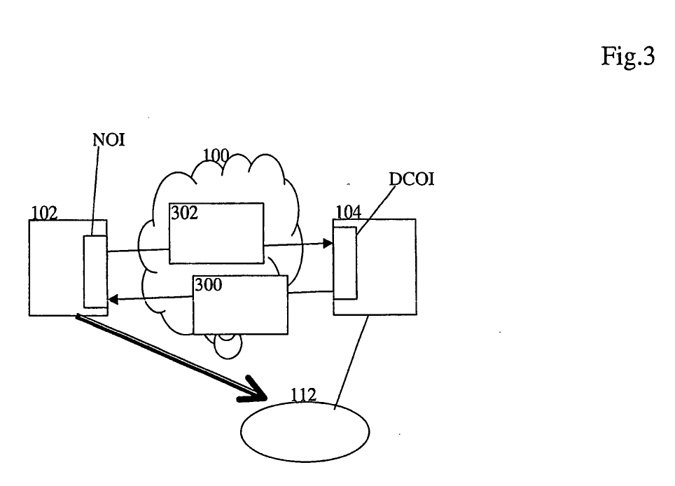

FIG. 3 shows process about the communication of bandwidth information. On the DCO (102) side the interface, via which data is exchanged with the NO (104), is called the NO interface (NOI). On the NO (104) side the interface, via which data is exchanged with the DCSS (110), is called the DCO interface (DCOI). Over the two interfaces, which are connected via the communication network (114), the available bandwidth of at least one channel in the digital broadcast network (112) is announced (Step 302). Thus, messaging is in principle from the NO (104) to the DCO (102). The step 300 can be considered mandatory. The bandwidth, which is needed for the transmission, is reserved or requested (Step 306). Thus, messaging is in principle in step 302 from the DCO (102) to NO (104). Using the interfaces repeatedly, a negotiation process can be implemented, so that several operators (TV or datacast) can compete for the NO's (104) bandwidth.

Bandwidth Announcement

Bandwidth announcements are sent from the network operator (NO) 104 to the datacast operator (DCO) 102, using file exchange by any means of data communication via the network (114) in the example of FIG. 1. This can be push (for example FTP or eMail) or pull (for example from a web site which is maintained by the NO (102). Any file format can be used to transfer data between the operators. The description below is only a technical example using Document Type Definion (DTD) as a specification language for extensible Markup Language (XML) files. Alternatively, the file structure or format can also be Extended Backup-Naur Form (EBNF) or Comma-separated values (CSV, ASCII based file format).

<!DOCTYPE NetworkBandwidthAnnouncement [
<!ELEMENT NetworkBandwidthAnnouncement (

ChannelBandwidthAnnouncement*
)>

<!ATTLIST NetworkBandwidthAnnouncement OperatorName CDATA #REQUIRED>
<!ELEMENT ChannelBandwidthAnnouncement (

(

GaranteedSlotBandwidthAnnouncement

|

ForecastSlotBandwidthAnnouncement

)*

)>

<!ATTLIST ChannelBandwidthAnnouncement ChannelID CDATA #REQUIRED>
<!ATTLIST ChannelBandwidthAnnouncement Date CDATA #REQUIRED>
<!ATTLIST ChannelBandwidthAnnouncement AvgOpportunisticBitRate CDATA

#IMPLIED>

<!ELEMENT GaranteedSlotBandwidthAnnouncement (EMPTY)>
<!ATTLIST GaranteedSlotBandwidthAnnouncement StartTime CDATA #REQUIRED>
<!ATTLIST GaranteedSlotBandwidthAnnouncement EndTime CDATA #REQUIRED>
<!ATTLIST GaranteedSlotBandwidthAnnouncement BitRate CDATA #REQUIRED>
<!ELEMENT ForecastSlotBandwidthAnnouncement (EMPTY)>
<!ATTLIST ForecastSlotBandwidthAnnouncement Probability CDATA #REQUIRED>
<!ATTLIST ForecastSlotBandwidthAnnouncement StartTime CDATA #REQUIRED>
<!ATTLIST ForecastSlotBandwidthAnnouncement EndTime CDATA #REQUIRED>
<!ATTLIST ForecastSlotBandwidthAnnouncement BitRate CDATA #REQUIRED>
]>

The semantics of the attributes in the technical example described above is as follows: (the example assumes that a DVB-T network is used as a multicast-enabled transmission network)

| Attribute | Semantics |
|---|---|
| Network Bandwidth | announcement of available bandwidth in the distribution |
| Announcement | system of the network operator for a certain calendar period |
| Network Operator Name | name of the network operator, used to distinguish between |
| | multiple network operators, if required |
| Channel Bandwidth | announcement of available bandwidth of 1 channel (ie. IP |
| Announcement | encapsulator) |
| Garanteed Slot | announcement of a time range inside which the bit rate does |
| Bandwidth | not vary and can for sure be used for datacasting |
| Announcement | |
| Forecast Slot Bandwidth | announcement of a time range inside which the bit rate does |
| Announcement | not vary and can with a high probability be used by the |
| | datacast operator. May be limited if it is not claimed by other |
| | operators who have higher priority |
| ChannelID | unique ID of the channel, defined by the network operator. |
| | This channel ID is used whenever bandwidth of this channel is |
| | announced. It corresponds to an MPE. |
| | The following information about the channel is defined by the |
| | network operator: |
| | PIDs that can be used for datacasting |
| | routing info |
| | DVB-T parameters |
| Date | date for which the slot announcement is made |
| AvgOpportunisticBitRate | heuristic average of opportunistic bandwidth that can be |
| | expected on that day, based on statistical information of similar |
| | days (eg. same day type) |
| Probability | heuristic probability for forecast bandwidth being available, |
| | based on statistical information of similar days (eg. same day |
| | type). |
| Start Time | start time (inside the date) of the slot |
| End Time | end time (inside the date) of the slot |
| Bit Rate | bit rate of the slot |

In a further embodiment of the invention a new bandwidth announcement can be generated by the NO (104) and transferred to the DCO (102) at most once a day, preferably before noon. The announced day range can be from the day following the current day up to 13 months in advance. The announced day range should be completed in such a way that no days are missing between the first and the last day which are announced. A day is announced completely, for example, there is defined all slots of all channels of the NO (104). The new announcement of a day overrides any earlier announcements. The guaranteed bandwidth (204) of a channel at any time of that day can only increase and usually never decrease. The forecast bandwidth (206), however, can also decrease.

Bandwidth Reservation

Bandwidth reservations and requests are sent from the NO (104) to the DCO (102), using file exchange by any means of data communication over the network (114) of FIG. 1. This can be push (for example FTP or eMail) or pull (for example on a web site maintained by the NO). Any file format can be used to transfer the data between the operators. The description below is only a technical example, below using Document Type Definion (DTD) as a specification language for extensible Markup Language (XML) files. Alternatively, file structure or format can also be EBNF or CSV.

<!DOCTYPE NetworkBandwidthReservation [
<!ELEMENT NetworkBandwidthReservation (

ChannelBandwidthReservation*
)>

<!ATTLIST NetworkBandwidthReservation OperatorName CDATA #REQUIRED>
<!ELEMENT ChannelBandwidthReservation (

(

SlotBandwidthReservation

|

SlotBandwidthRequest

)*

)>

<!ATTLIST ChannelBandwidthReservation ChannelID CDATA #REQUIRED>
<!ATTLIST ChannelBandwidthReservation Date CDATA #REQUIRED>
<!ELEMENT SlotBandwidthReservation (EMPTY)>
<!ATTLIST SlotBandwidthReservation StartTime CDATA #REQUIRED>
<!ATTLIST SlotBandwidthReservation EndTime CDATA #REQUIRED>
<!ATTLIST SlotBandwidthReservation BitRate CDATA #REQUIRED>
<!ELEMENT SlotBandwidthRequest (EMPTY)>
<!ATTLIST SlotBandwidthRequest StartTime CDATA #REQUIRED>
<!ATTLIST SlotBandwidthRequest EndTime CDATA #REQUIRED>
<!ATTLIST SlotBandwidthRequest BitRate CDATA #REQUIRED>
]>

The semantics of the attributes in the technical example described above is as follows: (the example assumes that a DVB-T network is used as a multicast-enabled transmission network)

| Attribute | Semantics |
|---|---|
| Network Bandwidth | reservation of available bandwidth in the distribution system |
| Reservation | of the network operator for a certain calendar period |
| Network Operator Name | name of the network operator, used to distinguish between |
| | multiple network operators, if required |
| Channel Bandwidth | reservation of available bandwidth of 1 channel (ie. IP |
| Reservation | encapsulator) |
| Slot Bandwidth | reservation of a time range inside which the bit rate does not |
| Reservation | vary within a slot (or within a combination of slots) that has in |
| | the latest announcement been specified as guaranteed |
| Slot Bandwidth Request | request for time range inside which the bit rate does not vary |
| | within a slot (or within a combination of slots) that has in the |
| | latest announcement been specified as forecast. |
| ChannelID | unique ID of the channel as defined by the network operator |
| Date | date for which the slot reservation or request is made |
| Start Time | start time (inside the date) of the slot |
| End Time | End time (inside the date) of the slot |
| Bit Rate | bit rate of the slot |

In a further embodiment of the invention a new bandwidth reservation request can be generated by the DCO (102) and transferred to the NO (104) at most once a day, preferably after noon. The day range can be from the day following the current day up to 13 months in advance. The day range should be completed in such a way that no days are missing between the first and the last day. New reservations and requests of a day override any earlier reservations or requests. The bandwidth reservations of a channel at any time of that day can increase but never decrease. However, if the NO (104) does not guarantee the bandwidth and the bandwidth is requested, the transmitted bandwidth may decrease. For example, there is requested the opportunistic bandwidth (208) or the forecast bandwidth (206), and they are cannot be transmitted because the DBN (112) does not have the available bandwidth, the transmitted bandwidth may decrease.

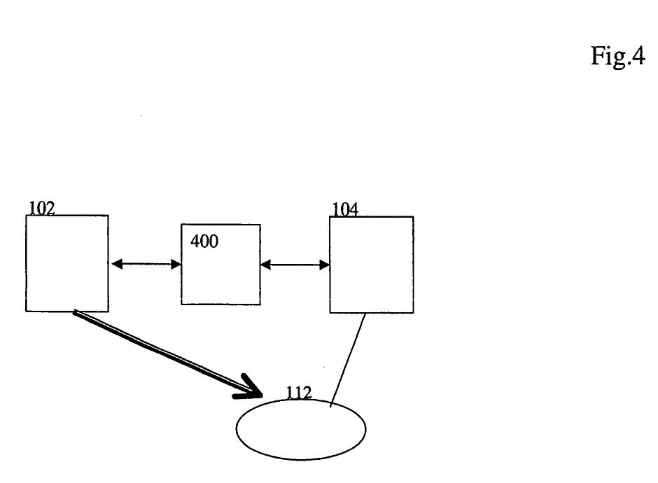

FIG. 4 shows an example of a system where a web-site intermediates bandwidth information between a datacast operator and a network operator. In the embodiment, the network operator (NO) 102 and the datacast operator (DCO) 104 can set up an interface that couples them with each other. This kind of interface is preferably a web-site (400). From the web-site (400) information about the bandwidth availability is retrieved by the DCO (102). Correspondingly, the bandwidth reservation requests can be given to the same site, for example as HTTP requests. In this case, the DCO (102) gives the requests and the NO (104) can allocate the bandwidth accordingly. The interface may be custom software running on a computer (not shown) used by the datacast and network operators (102, 104). For example, the software could be written in Java and interface with the scheduling intelligence using a technique such as SOAP (Simple Object Access Protocol), RMI (remote method invocation), or JMS (Java Messaging Service) over a data link between the operators. This link could be, for example, the internet or a private network. Alternately, the software could be written in Objective-C or Java and could interface with the scheduling intelligence module using the Distributed Objects functionality provided by Apple Computer's Cocoa frameworks. In another embodiment, a web browser could be used to interface with the scheduling intelligence.

The web interface (400) may be implemented as is known in the art using, for example, Java Server Pages (JSP) to update the web interface (400) in accordance with the interaction with the scheduling system. In certain embodiments, the software or web browser interface may be constructed using Apple Computer's Web Objects.

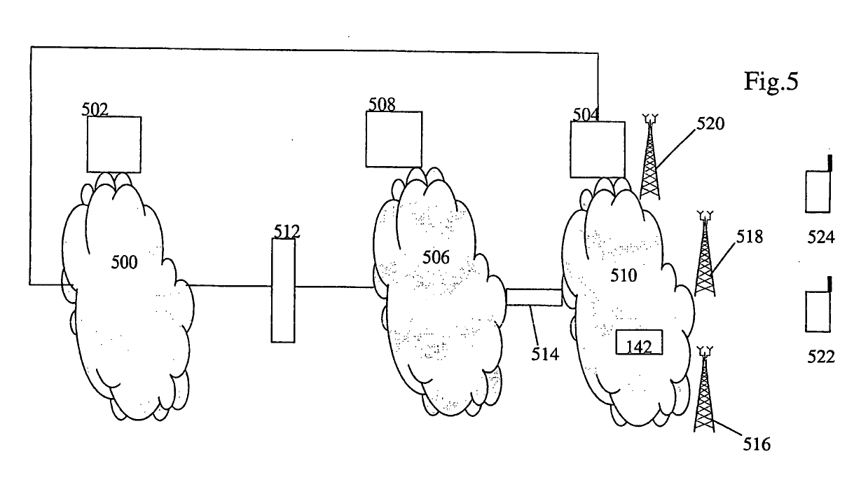

FIG. 5 shows an embodiment of a system architecture of the IPDC service system. A network (500) of computing system is coupled with a Content provider (CP) computer (502). The network (500) provides also a connection between a network operator (NO) computer (504), an interaction channel (not shown), and the datacast system (506, 508). The network (500) is in this example the Internet. The CP computer (502) defines services and service items. The NO computer (504) can announce the available bandwidth of a digital broadcast network (DBN) 510 to a Datacast Operator (DCO) computer (508). The NO computer (504) is also coupled with the digital broadcast network (DBN) 510. A firewall (512) couples the network (500) in secure manner with a datacast operator (DCO) network (506). The DCO network (506) can be a Local Area Network (LAN). The DCO network (506) is coupled with the DBN (510) via a router (514). The DCO network (506) provides means for transferring IP based packet data. The DCO computer (508) can reserve or request the available bandwidth from the NO computer (504). In the example of FIG. 5, the DBN (510) comprises three transmission stations (516, 518, 520). IP based data service can be wirelessly broadcast to wireless terminals (522, 524) via the transmission stations (516, 518, 520) of the DBN (510).

Particular implementations and embodiments of the invention have been described. It is clear to a person skilled in the art that the invention is not restricted to details of the embodiments presented above, but that it can be implemented in other embodiments using equivalent means without deviating from the characteristics of the invention. The scope of the invention is only restricted by the attached patent claims. For example, the transmission network can be any network which enables the wireless transmission of IP based packet data, and where the transmission can be multicast. The transmission network can comprise both wireless link and fixed line systems.

1. A method for communicating bandwidth information of a digital broadcast network between a datacast operator, which datacast operator arranges data content to a network operator, and the network operator operating the digital broadcast network, the method comprising:
announcing available bandwidth of at least one channel of the digital broadcast network to the datacast operator for a period of time by the network operator of the digital broadcast network, and
reserving at least part of said announced bandwidth of the digital broadcast network for said period of time by the datacast operator, wherein the bandwidth is categorized as:
a guaranteed bandwidth allocated to said datacast operator, and
a forecast bandwidth announced to multiple operators and further allocated to said datacast operator by a further request if there is available bandwidth.

2. The method according to claim 1, wherein the digital broadcast network comprises a digital video broadcasting (DVB) network.

3. The method according to claim 2, wherein the DVB network comprises a terrestrial digital video broadcasting (DVB-T) network.

4. The method according to claim 3, wherein the DVB-T comprises transmission stations forming channels for wirelessly broadcasting data to at least one wireless terminal.

5. The method according to claim 4, wherein the bandwidth information is maintained, announced and reserved for each transmission channel independently.

6. The method according to claim 1, wherein the certain period of time comprises the time during which a transmission bit rate of the digital broadcast network is constant.

7. (Cancelled)

8. The method according to claim 1, wherein the bandwidth information is contained in a file which is transferred between the datacast operator and the network operator.

9. The method according to claim 8, wherein the file, if the file is sent from the network operator to the datacast operator, comprises data about available bandwidth of the network for the certain period of time, network operator name, channel bandwidth announcement, guaranteed slot bandwidth announcement, forecast slot bandwidth announcement, channel identity, date, opportunist bandwidth bit rate, probability of the forecast bandwidth, star time of the slot, end time of the slot and bit rate of the slot.

10. The method according to claim 8, wherein the file, if the file is sent from the datacast operator to the network operator, comprises data about available bandwidth of the network for the certain period of time, network operator name, channel bandwidth reservation, slot bandwidth reservation, slot bandwidth request, channel identity, date for which slot reservation is made, star time of the slot, end time of the slot and bit rate of the slot.

11. The method according to claim 1, further comprising scheduling a transmission of the digital broadcast network according to the available bandwidth in time-dependent manner.

12. A method for communicating bandwidth information of a digital broadcast network between a datacast operator, which datacast operator arranges data content to a network operator, and the network operator operating the digital broadcast network, the method comprising:
at least one available bandwidth announcement is sent from the network operator to the datacast operator in order to announce available bandwidth of at least one channel of the digital broadcast network for a transmission via the digital broadcast network for the datacast operator, wherein the bandwidth is categorized as:
a guaranteed bandwidth allocated to said datacast operator, and
a forecast bandwidth announced to multiple operators and further allocated to said datacast operator by a further request if there is available bandwidth.

13. A method for communicating bandwidth information of a digital broadcast network between a datacast operator, which datacast operator arranges data content to a network operator, and the network operator operating the digital broadcast network, the method comprising:
at least one bandwidth reservation request is sent from the datacast operator to the network operator in order to reserve bandwidth of at least one channel of the digital broadcast network for a transmission via the digital broadcast network for the datacast operator, wherein the bandwidth is categorized as:
a guaranteed bandwidth allocated to said datacast operator, and
a forecast bandwidth announced to multiple operators and further allocated to said datacast operator by a further request if there is available bandwidth.

14. A system for communicating bandwidth information of a digital broadcast network between a datacast operator, which datacast operator arranges data content to a network operator, and the network operator operating the digital broadcast network, the system comprising:
a first computing system of the network operator for announcing available bandwidth of at least one channel of the digital broadcast network to the datacast operator, wherein the first computing system is coupled with the network of computing systems and with the digital broadcast network,
a second computing system of the datacast operator for reserving bandwidth of at least one channel of the digital broadcast network from the network operator, wherein the second computing system is coupled with a network of computing systems and with the digital broadcast network, and
the digital broadcast network is adapted to multicast data content wirelessly to at least one end-user, wherein the bandwidth is adapted to be categorized as:
a guaranteed bandwidth adapted to be allocated to said datacast operator, and
a forecast bandwidth adapted to be announced to multiple operators and further adapted to be allocated to said datacast operator by a further request if there is available bandwidth.

15. The system according to claim 14, wherein the bandwidth is further adapted to be categorized as an opportunistic band which is not particularly announced to any operators, however, the opportunistic bandwidth being usable by any operator if there is available bandwidth.

16. The system according to claim 15, wherein the opportunistic bandwidth is adapted to be usable in non-time dependent manner.

17. The system according to claim 15, wherein an estimate of the opportunistic bandwidth is announced.

18. The system according to claim 15, further comprising an interface between the datacast operator and the network operator for intermediating bandwidth information in time-dependent manner.

19. An interface for communicating bandwidth information of at least one channel of a digital broadcast network between a datacast operator, which datacast operator arranges data content to a network operator, and the network operator operating the digital broadcast network, wherein the interface is set up at a computing system of the network operator and at a computing system of the datacast operator, the interface being adapted to transfer:
a bandwidth announcement to the datacast operator, the bandwidth announcement which the network operator makes available to the datacast operator for datacasting for a period of time, and
a bandwidth reservation request to the network operator, the bandwidth reservation request which the datacast operator needs for datacasting for a period of time, wherein the bandwidth is adapted to be categorized as:
a guaranteed bandwidth adapted to be allocated to said datacast operator, and
a forecast bandwidth adapted to be announced to multiple operators and further adapted to be allocated to said datacast operator by a further request if there is available bandwidth.

20. The interface according to claim 19, wherein the interface comprises a web site, which is commonly maintained by the datacast operator and the network operator, providing a connection between the operators via Internet.

21. A computer program product comprising programs of instructions executable by a computer for communicating bandwidth information of at least one channel of a digital broadcast network between a datacast operator, which datacast operator arranges data content to a network operator, and the network operator operating the digital broadcast network, the computer program product comprising:
computer program code for causing the computer to announce available bandwidth of at least one channel of the digital broadcast network to a datacast operator for a period of time by the network operator of the digital broadcast network,
computer program code for causing the computer to reserve the bandwidth of the digital broadcast network for a period of time by the datacast operator,
wherein the bandwidth is specified in a time-dependent manner and the bandwidth is adapted to be categorized as:
a guaranteed bandwidth adapted to be allocated to said datacast operator, and
a forecast bandwidth adapted to be announced to multiple operators and further adapted to be allocated to said datacast operator by a further request if there is available bandwidth.

22. The method according to claim 1, wherein the bandwidth is further categorized as an opportunistic band which is not particularly announced to any operators, however, the opportunistic bandwidth being usable by any operator if there is available bandwidth.

23. The method according to claim 22, wherein the opportunistic bandwidth is adapted to be usable in non-time dependent manner.

24. The method according to claim 22, wherein an estimate of the opportunistic bandwidth is announced.

25. The system according to claim 15, further comprising end-user's at least one wireless terminal for receiving content via the digital broadcast network and for interaction via at least the network of computing system.

26. The system according to claim 15, wherein the digital broadcast network comprises terrestrial digital video broadcasting network (DVB-T) and the network of computing systems comprises Internet.

27. The interface according to claim 19, wherein the bandwidth is further adapted to be categorized as an opportunistic band which is not particularly announced to any operators, however, the opportunistic bandwidth being usable by any operator if there is available bandwidth.

28. The interface according to claim 27, wherein the opportunistic bandwidth is adapted to be usable in non-time dependent manner.

29. The interface according to claim 27, wherein an estimate of the opportunistic bandwidth is adapted to be announced.
